(19) United States
(12) Patent Application Publication
(10) Pub. No.: US 2006/0129641 A1
(43) Pub. Date: Jun. 15, 2006

(54) Method of limiting the number of simultaneous conversations in an instant messaging system

(75) Inventors: Olivier Briand, Caen (FR); Vinvent Auvray, Caen (FR); Anthony Dauguet, Saint Pierre du Fresne (FR)

Correspondence Address: COHEN, PONTANI, LIEBERMAN & PAVANE, Suite 1210, 551 Fifth Avenue, New York, NY, 10176, US

(73) Assignee: France Telecom, Paris (FR)

(21) Appl. No.: 11/299,872

(22) Filed: Dec. 12, 2005

(30) Foreign Application Priority Data
Dec. 15, 2004 (FR) 0413316

(51) Int. Cl. G06F 15/16

(52) U.S. Cl. 709/204

(57) ABSTRACT

The invention relates to a method of limiting the number of simultaneous conversations in an instant messaging service comprising a plurality of instant messaging clients connected to an instant messaging server. Each instant messaging client has a presence status that can be seen by the other instant messaging clients in its own contacts list, said presence status varying at least between “Available” and “Busy”. According to the invention, when the number of simultaneous conversations for an instant messaging client reaches a predetermined number, said instant messaging client is seen as “Busy” for all the instant messaging clients in its own contacts list, other than those already in conversation therewith.

### FIELD OF THE INVENTION

The present invention relates to the field of instant messaging systems. It relates more particularly to limiting the number of simultaneous conversations in instant messaging systems.

### PRIOR ART

Instant messaging systems enable users to exchange messages in real time. FIG. 2 shows a simplified example of a standard instant messaging system which comprises an instant messaging server 100 to which two users A and B are connected via respective instant messaging clients C_A and C_B. The server 100 comprises a main instant messaging module 110 for managing the presence of instant messaging clients and the exchange of messages between them as a function of instant message routing rules. This module also manages each instant messaging client's lists of contacts 120, also known as “buddy lists”, such as the lists 121 and 122 corresponding to the contacts lists of users A and B, respectively.

The presence/availability status of a user is a dynamic parameter visible to other users, may generally vary between “On line” and “Away” or between “Available” and “Busy”, and defines the user's communication capacity for the whole of the contacts list. It is users who decide their own presence status.

In FIG. 2, when user B wishes to communicate with user A by means of instant messages, user B first consults user A's presence status as indicated in user B's contacts list 122. If user A has set the presence parameter to “Available”, for example, then user B knows that user A can receive a message immediately and enter into communication. On the other hand, if user A's presence status as indicated in User B's contacts list corresponds to “Away” or “Busy”, then user B knows that user A is temporarily unavailable and will not respond immediately.

At present, an instant messaging user can be “Busy” either totally or partly. When partly busy, a user may be “Busy” for 90% of a contacts list, for example, but “Available” for the remaining 10%. This differentiated availability management concept enables a user to choose, for a given period, the contact or contacts from a contacts list with whom that user is willing to communicate.

However, the user is not able to limit the number of simultaneous conversations, i.e. the number of requests emanating from the contacts list. In particular, this lack of means for limiting simultaneous conversations represents a significant drawback because of the growing use of instant messaging in business, a situation in which the number of simultaneous requests can quickly become very large. Without control over the number of simultaneous conversations, and from a given number of simultaneous conversations, for example three simultaneous conversations, it is difficult for the user to respond quickly to everyone, even though this is the essential concept of instant messaging.

### SUBJECT MATTER AND BRIEF DESCRIPTION OF THE INVENTION

The present invention aims to eliminate the above-mentioned drawbacks and to propose a technical solution enabling an instant messaging user to decide the maximum number of simultaneous conversations in which that user wishes to participate.

Those objectives are achieved by a method of limiting the number of simultaneous conversations in an instant messaging service comprising a plurality of instant messaging clients connected to an instant messaging server, each instant messaging client having a presence status that can be seen by the other instant messaging clients in its own contacts list, said presence status varying at least between “Available” and “Busy”, wherein, when the number of simultaneous conversations for an instant messaging client reaches a predetermined number, said instant messaging client is seen with the “Busy” status for all the instant messaging clients in its own contacts list other than those already in conversation therewith.

Thus the method of the present invention enables an instant messaging user to define the maximum number of simultaneous conversations in which that user wishes to participate. User presence management is consequently effected automatically as a function of the number of simultaneous conversations in progress.

The user decides the number of simultaneous conversations not to be exceeded by using the corresponding instant messaging client to configure the predetermined number of simultaneous conversations, that number then being sent to the instant messaging server and stored in a database. In this way each user can freely set and update the number of simultaneous conversations in which that user wishes to participate. Moreover, the predetermined number of simultaneous conversations specific to each instant messaging client is communicated to the corresponding instant messaging client each time it is started up. In this way, the instant messaging client is informed in each new session of the number of simultaneous conversations that it may authorize. The user does not need to configure this number each time the instant messaging client is used.

The instant messaging server stores messages sent by instant messaging clients to some other messaging client for which the maximum number of simultaneous conversations has already been reached. These messages can therefore be retained until the instant messaging client becomes available again for those instant messaging clients and ensures that in any event messages in the instant messaging system are tracked.

The present invention also consists in an instant messaging server comprising a main instant messaging module for managing the exchange of instant messages between instant messaging clients, said main module being connected to a contacts lists module containing contacts lists of the instant messaging clients, which server further comprises a module for managing the number of simultaneous conversations which, when the number of simultaneous conversations for an instant messaging client reaches a predetermined number, changes the presence status of said instant messaging client to “Busy” for all the instant messaging clients in its contacts list except for those already in conversation therewith.

The technical solution proposed by the invention to limiting the number of simultaneous conversations for an instant messaging client in an instant messaging server does not require any modification of the main messaging module. Consequently, this solution can easily be integrated into instant messaging servers that are already installed.

To avoid the user having to configure a messaging client each time it is used, the instant messaging server further comprises a database for limiting the number of simultaneous conversations, which database stores the predetermined number of simultaneous conversations configured by each instant messaging client. On each messaging client start-up (session opening), the instant messaging server communicates to the client the predetermined number of simultaneous conversations stored for that client.

The server also comprises means for storing instant messages sent by instant messaging clients for which said instant messaging client is seen as “Busy”. These messages can therefore be held at the server until there is a change in the presence status of the destination instant messaging client.

The invention further consists in an instant messaging system comprising a plurality of instant messaging clients in communication with one or more instant messaging servers as described above.

To enable the user to fix the maximum number of simultaneous conversations in which that user wishes to participate, the instant messaging clients include interface means for configuring a predetermined number of simultaneous conversations and for sending an instant messaging server a message reporting its saturated status when the number of simultaneous conversations reaches the predetermined number.

### BRIEF DESCRIPTION OF THE DRAWINGS

Other features and advantages of the invention emerge from the following description of particular embodiments of the invention, which are provided by way of non-limiting example; the description is given with reference to the appended drawings, in which:

FIG. 1 is a general diagram of one embodiment of an instant messaging system of the invention; and

FIG. 2 is a diagram of a prior art instant messaging system.

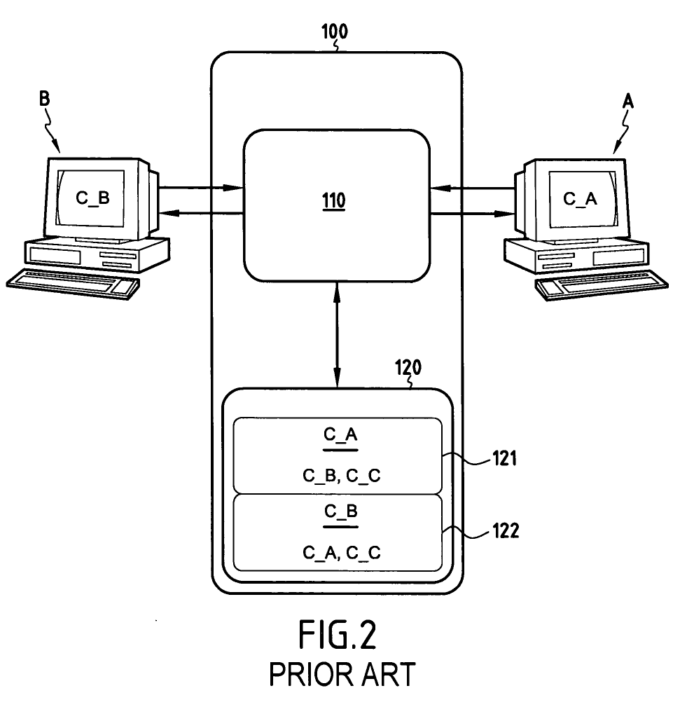

### DETAILED DESCRIPTION OF EMBODIMENTS OF THE INVENTION

The present invention applies to instant messaging systems and proposes to integrate functions, essentially in the form of software, into the instant messaging servers usually employed for instantaneous exchange of messages between users. The proposed functions are compatible with current instant messaging service standards and protocols and so they can be integrated both into new instant messaging servers and into servers already installed.

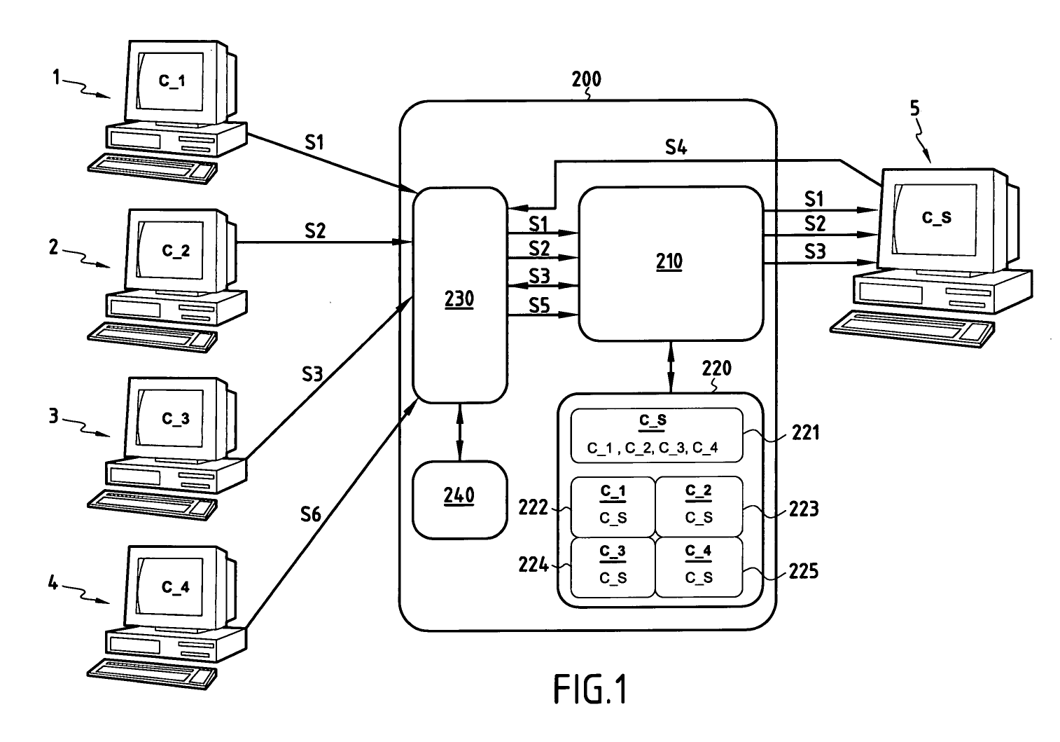

FIG. 1 is a diagrammatic overview of a system of the invention showing the various portions thereof operative in the method of the invention. The portions that are operative mainly during limitation of the number of simultaneous conversations comprise one or more (here four) requesting users, each of whom has a terminal including an instant messaging client (C_1, C_2, C_3 and C_4), a requested user 5 who has a terminal equipped with an instant messaging client C_S, and an instant messaging server 200. The instant messaging client (or user agent) software enables a user to access an instant messaging service via a server using a specific identifier. This is known in the art. The instant messaging client is used in particular to compose and receive messages. It also enables users to access the instant messaging server to manage their own contacts lists.

For simplicity, the FIG. 1 system is shown with four requesting instant messaging clients and one requested instant messaging client. Nevertheless, in the light of the description below, the person skilled in the art can easily envisage the implementation of a system of this kind on a larger scale, i.e. with a different number of requesting and requested users, and in particular a greater number thereof.

In the FIG. 1 example, the users' terminals for sending and receiving messages are fixed terminals of the personal computer type connected to a data network. However, the present invention applies generally to all terminals that include means for sending and receiving instant messages via a communications network (e.g. mobile telephones and personal digital assistants).

The communications network (not shown) via which the user terminals are connected to the instant messaging server may be an “open” network, such as the Internet, a “closed” network, such as an Intranet business network, or a “partially open” network (i.e. one using a closed network and an open network at the same time).

The instant messaging server 200 enables instant messages to be exchanged between two or more users who are seen by the server as uniquely defined by their respective identifiers. The instant messaging server 200 comprises a main instant messaging module 210, a contacts list module 220, a module 230 for managing the number of simultaneous conversations, and a database 240 for the limit numbers of simultaneous conversations.

The main instant messaging module 210, which is a software element of an instant messaging server known in the art (transfer agent), provides presence management and exchange of messages between the instant messaging clients as a function of instant message routing rules. It also manages contacts lists.

The module 220 is a database that is an integral part of the instant messaging server and contains the contacts lists of all of the messaging clients; in the present example these are the contacts lists 221, 222, 223, 224 and 225 of the clients C_S, C_1, C_2, C_3 and C_4, respectively.

The module 230 for managing the number of simultaneous conversations is an element specific to the present invention. On the server side, it manages access to the instant messaging clients of users who have activated the service for limiting the number of simultaneous conversations. It interfaces with the main instant messaging module 210 to determine the saturated or non-saturated status (i.e. whether the maximum number of simultaneous conversations has been reached or not) of an instant messaging client and modifies its presence status accordingly. The module 230 is further interfaced with the requested instant messaging clients to perform differentiated presence management in the event that one of those clients reaches its maximum number of simultaneous conversations. All messages coming from an instant messaging client pass first through the module 230, which then forwards them to the main module 210.

The module 230 for managing the number of simultaneous conversations may be coded in a language such as C++ or Java. It can therefore be integrated into the architecture of an instant messaging server (e.g. Jabber) and in this case use the standardized extensible Messaging and Presence Protocol (XMPP), which is an instant messaging protocol based on XML. If the module of the invention for managing the number of simultaneous conversations is integrated into an instant messaging server, whether it is one that exists already or a new server, it must use a protocol compatible with that used by the main module of the instant messaging server.

The database 240 used to limit number of simultaneous conversations is interfaced with the module 230 for managing the number of simultaneous conversations to store the value of a parameter N that represents the maximum number of simultaneous conversations for each user of the instant messaging service. This module is requested by the module 230 on starting up an instant messaging client and each time that the module 230 needs to know the parameter N.

The module 230 interrogates the database 240 containing the preferences of the requested instant messaging client, here the client C_S, and extracts from it the value linked to the service for limiting simultaneous conversations, which it communicates to the instant messaging client when it is started up. If this value is set at a maximum of three simultaneous conversations, for example, the module 230 is not active in the exchange of messages and in differentiated presence management providing the number of simultaneous conversations has not reached three. When the number of simultaneous conversations reaches three, the instant messaging client C_S sends a message to the module 230 reporting its “saturated” status, the client C_S then being in conversation with three instant messaging clients, for example the clients C_1, C_2 and C_3. The module 230 is then activated for the user 5 of the instant messaging client C_S. The module 230 also acts in association with the instant messaging clients of other users of the instant messaging service with the exception of those of the three users already in conversation with the user 5, that is to say the users 1, 2 and 3 (instant messaging clients C_1, C_2 and C_3) in the present example. For all other instant messaging users, the presence status of the user 5 becomes “Busy” and new messages sent to the instant messaging client C_S of the user 5 by users other than the users 1 to 3 are managed in the same way as for the “Offline” status, i.e. they are stored in the instant messaging server 200 waiting for a change in the presence status of the user 5. When one of the conversations between the instant messaging client C_S and C_1 or C_2 or C_3 stops, the instant messaging client C_S sends a message to the module 230 to inform it that the “Saturated” status no longer applies. The presence status of the messaging client C_S changes from “Busy” to “Available” and messages that were stored in the server and sent by messaging clients other than the clients C_1 to C_3 are sent to it. The module 230 becomes inactive until the number of simultaneous conversations is again equal to three.

Users configure the maximum numbers of simultaneous conversations directly in the instant messaging server using their instant messaging clients. To this end the user of the instant messaging client C_S, for example the user 5, effects the configuration process by selecting, for example, a “Limit the number of simultaneous conversations” option in the menu of the instant messaging client. Making this selection triggers the opening of a window which prompts for a value for the parameter N corresponding to the maximum number of simultaneous conversations to be authorized, i.e. the maximum number of contacts in the instant messaging system to be allowed to call that user simultaneously. Once the value of the parameter N has been entered, for example the value 3, the instant messaging client C_S sends a message containing the value of the parameter N to the module 230 for managing the number of simultaneous conversations. The module 230 retains this value in the database 240 for limiting the number of simultaneous conversations. Each time that the instant messaging client C_S is started up (i.e. on opening each new session), the module 230 interrogates the database 240 and informs the instant messaging client C_S of the value of the parameter N.

There follows a description of an embodiment of the method of the invention in the FIG. 1 system in which the steps of an operation to limit the number of simultaneous conversations are represented by arrows S1 to S6. Naturally, the method of the invention includes a preliminary step of configuring the number of simultaneous discussions and a step of that number being loaded by the instant messaging client who is going to be requested, as explained above.

The embodiment to be described is based on the following assumptions:

the users 1 to 4 of the respective instant messaging clients C_1 to C_4 are included in the contacts list 221 belonging to the user 5 of the requested instant messaging client C_S, which itself is included in the respective contacts lists 222 to 225 of the instant messaging clients C_1 to C_4;

the user 5 has configured the instant messaging client C_S to limit the maximum number of simultaneous conversations to three;

the instant messaging clients C_1 to C_3 all request the instant messaging client C_S within a time that is sufficiently short for the client C_S to be managing three simultaneous conversations when the request arrives from the fourth instant messaging client C_4.

In a first step S1, the instant messaging client C_1 wishes to exchange instant messages with the instant messaging client C_S. This is the first conversation of the client C_S. The number of simultaneous conversations has not yet reached three, so the server does not block the instant message that reaches the instant messaging server C_S and the conversation begins. The instant messaging client C_2 also wishes to exchange instant messages with the instant messaging client C_S. This is the simultaneous second conversation for the client C_S. The number of simultaneous conversations has not exceeded three, the server does not block the instant message from the client C_2, which reaches the instant messaging client C_S, and the conversation begins (step S2).

The third instant messaging client C_3 also wishes to converse with the instant messaging client C_S. This is the simultaneous third conversation for C_S. The number of simultaneous conversations has not exceeded the maximum number (three), so the server does not block the instant message from C_3, which reaches the instant messaging client C_S, and the conversation begins (step S3).

However, once this third conversation has begun, the instant messaging client C_S has reached its maximum number of simultaneous conversations. It then sends a message to the module 230 for managing the number of simultaneous conversations informing it of this “Saturated” status (step S4). The instant messaging client C_S is then in simultaneous conversation with the three instant messaging clients C_1 to C_3.

The module 230 informs the main instant messaging module 210 that the instant messaging client C_S is now “Busy” for all the instant messaging clients in its contacts lists 221 except for the three instant messaging clients C_1 to C 3 already in conversation (step S5). New messages sent to the instant messaging client C_S other than those coming from clients C_1 to C_3 are managed in the same way as for the “Offline” status; for example, if the instant messaging client C_4 sends a message to the instant messaging client C_S, this message will not get past the module 230, which stores it on the instant messaging server 200 pending a change in the presence status of the messaging client C_S (step S6). The instant messaging client C_4 sees the status of the instant messaging client C_S as “Busy”, whereas the instant messaging clients C_1 to C_3 see it as “Available”. The conversations between client C_S and clients C_1 to C_3 continue.

If a conversation between one of the instant messaging clients C_1 to C_3 and the instant messaging client C_S ends, then client C_S sends a message to the module 230 telling it that its status is no longer “Saturated”. The presence status of the instant messaging client C_S goes from “Busy” to “Available” for all members of its contacts list 221. The module 230 becomes inactive until the number of simultaneous conversations again reaches three.

Optionally, certain instant messaging clients may be recognized as priority clients to which the rules limiting the number of simultaneous conversations do not apply. For example, each user can set parameters for such clients in their own contacts list so as to be always available for priority clients even if the maximum number of simultaneous conversations has already been reached.

What is claimed is:

1. A method of limiting the number of simultaneous conversations in an instant messaging service comprising a plurality of instant messaging clients connected to an instant messaging server, each instant messaging client having a presence status that can be seen by the other instant messaging clients in its own contacts list, said presence status varying at least between “Available” and “Busy”, wherein, when the number of simultaneous conversations for an instant messaging client reaches a predetermined number, said instant messaging client is seen as “Busy” for all the instant messaging clients in its own contacts list, other than those already in conversation therewith.

2. A method according to claim 1, wherein a user uses an instant messaging client to configure the predetermined number of simultaneous conversations, and said number is then sent to the instant messaging server and stored in a database used to limit the number of simultaneous conversations.

3. A method according to claim 1, wherein the predetermined number of simultaneous conversations is communicated to an instant messaging client each time it is started up.

4. A method according to claim 1, wherein, when the number of simultaneous conversations for an instant messaging client reaches a predetermined number, instant messages sent by the instant messaging clients in the contacts list of said instant messaging client, other than those already in conversation therewith, are stored in the instant messaging server.

5. An instant messaging server comprising a main instant messaging module for managing the exchange of instant messages between instant messaging clients, said main module being connected to a contacts lists module containing contacts lists of the instant messaging clients, each instant messaging client having a presence status that can be seen by the other instant messaging clients in its own contacts list, said presence status varying at least between “Available” and “Busy”, which server further comprises a module for managing the number of simultaneous conversations which, when the number of simultaneous conversations for an instant messaging client reaches a predetermined number, changes the presence status of that instant messaging client to “Busy” for all the instant messaging clients in its own contacts list except for those already in conversation therewith.

6. A server according to claim 5, wherein, in order to limit the number of simultaneous conversations, it further comprises a database for storing the predetermined number of simultaneous conversations configured by each instant messaging client.

7. A server according to claim 6, including means for communicating the predetermined number of simultaneous conversations corresponding to an instant messaging client each time the client is started up.

8. A server according to claim 5, comprising means for storing instant messages sent by instant messaging clients by which said instant messaging client is seen as “Busy”.

9. An instant messaging system comprising a plurality of instant messaging clients connected to one or more instant messaging servers according to claim 5.

10. A system according to claim 9, wherein the instant messaging clients include interface means for configuring a predetermined number of simultaneous conversations.

11. An instant messaging client, comprising interface means for configuring a predetermined number of simultaneous conversations and for sending an instant messaging server a message reporting its saturated status when the number of simultaneous conversations reaches the predetermined number.
